(19) United States
(12) Patent Application Publication
(10) Pub. No.: US 2009/0029878 A1
(43) Pub. Date: Jan. 29, 2009

(54) DRILLING FLUID, DRILL-IN FLUID, COMPLETITION FLUID, AND WORKOVER FLUID ADDITIVE COMPOSITIONS CONTAINING THERMOSET NANOCOMPOSITE PARTICLES; AND APPLICATIONS FOR FLUID LOSS CONTROL AND WELLBORE STRENGTHENING

(76) Inventor: Jozef BICERANO, Midland, MI (US)

Correspondence Address: MORGAN, LEWIS & BOCKIUS LLP, 1701 MARKET STREET, PHILADELPHIA, PA, 19103-2921, US

(21) Appl. No.: 12/178,785

(22) Filed: Jul. 24, 2008

Related U.S. Application Data
(60) Provisional application No. 60/951,518, filed on Jul. 24, 2007.

(51) Int. Cl. C09K 8/20; C09K 8/00

(52) U.S. Cl. 507/107; 507/140; 507/145; 507/139; 507/117

(57) ABSTRACT

In one aspect, this invention relates to the use of thermoset nanocomposite particles as components of drilling fluid, drill-in fluid, completion fluid, and workover fluid additive packages to reduce fluid losses to a formation and/or to enhance a wellbore strength. In another aspect, this invention relates to the use particles of specific gravity ranging from about 0.75 to about 1.75 as components of drilling fluid, drill-in fluid, completion fluid, and workover fluid additive packages to reduce fluid losses to a formation and/or to enhance a wellbore strength. Using embodiments of the invention, reduction of fluid loss and/or enhancement of wellbore strength may be achieved while working with water-based, oil-based, invert emulsion, or synthetic drilling muds. The currently most preferred embodiments of the invention use substantially spherical thermoset nanocomposite particles, possessing a specific gravity from approximately 1.02 to approximately 1.15 wherein the matrix is a terpolymer of styrene, ethylvinylbenzene and divinylbenzene, and wherein carbon black particles possessing a length that is less than about 0.5 microns in at least one principal axis direction are incorporated as a nanofiller.

### CROSS-REFERENCE TO RELATED APPLICATIONS

This application claims priority to U.S. Provisional Application No. 60/951,518, filed Jul. 24, 2007, entitled “Product for Propping Open Near-Wellbore Fractures and Sealing Microfractures”, which is incorporated herein by reference.

### FIELD OF THE INVENTION

In one aspect, this invention relates to the use of thermoset nanocomposite particles as components of drilling fluid, drill-in fluid, completion fluid, and workover fluid additive packages to reduce fluid losses to a formation and/or to enhance a wellbore strength. In another aspect, this invention relates to the use particles of specific gravity ranging from about 0.75 to about 1.75 as components of drilling fluid, drill-in fluid, completion fluid, and workover fluid additive packages to reduce fluid losses to a formation and/or to enhance a wellbore strength. Using embodiments of the invention, reduction of fluid loss and/or enhancement of wellbore strength may be achieved while working with water-based, oil-based, invert emulsion, or synthetic drilling muds.

### BACKGROUND

### A. Broad Overview

Fluid loss is a measure of the tendency of the liquid phase of a drilling fluid to pass through the filter cake into the formation. A sufficiently low fluid loss value and the deposition of a thin filter cake possessing a low permeability are often essential factors for the successful performance of a drilling mud. The relative importance of these filtration characteristics depends on the formation that is being penetrated. For example, drilling muds manifesting much higher fluid loss can be used in the hard rock formations of the Rocky Mountains and West Texas than in the sloughing, heaving, hydratable shales of the Gulf Coast Area. Experience in an area therefore often serves as a guide to determining the fluid loss specifications for a drilling mud program. Many difficulties may occur in drilling, completion, and workover operations due to the use of a drilling mud with faulty filtration characteristics such as excessive filtration (fluid loss) rates and/or the buildup of a thick filter cake. Excessive fluid loss can impede the evaluation of a formation since the recovery of the filtrate in addition to the formation fluids by the test tools can make it difficult to determine the true fluid content of the formation. More extreme fluid loss can even damage the formation. The buildup of a thick filter cake can introduce tight spots in a hole causing excessive drag, greatly increase pressure surges due to the decreased pipe diameter when moving the pipe, differential pressure sticking of the drill string due to increased area of contact in thick filter cake and rapid buildup of sticking force in filter cake of high permeability, primary cementing problems due to poor displacement of dehydrated mud and excessively thick filter cakes, and difficulties with evaluating a formation. It is, therefore, important in many applications of drilling muds to use additives that can improve the filtration characteristics of the mud. Such additives are most commonly referred to as “fluid loss control agents”. The benefits of fluid loss control include the strengthening of a wellbore by reducing the formation damage and other difficulties that can result from excessive fluid loss.

In addition, drilling muds may also contain additives that are intended to help achieve wellbore strengthening by modifying the fracture mechanics of the formation. In this “mechanical” approach, the operating mud window is widened by increasing the shear strength of the formation and/or increasing the compressive tangential stress in the near-wellbore region. The term “stress cage formation” is used by some workers in the field to refer to the increase of the compressive tangential stress in the near-wellbore region as a result of the incorporation of additives commonly referred to as “bridging agents” across open fractures in a formation. The recognition of stress cage formation as a distinct mechanism for wellbore strengthening which can provide additional benefits beyond the benefits of achieving improved fluid loss control, and the inception of work intended to design drilling fluid additive packages tailored specifically to maximize the extent and effectiveness of stress cage formation, is a more recent development than the decades-old use of fluid loss control agents.

It should also be noted that drilling fluid additives intended to achieve the beneficial effects summarized in the two paragraphs above can often have multiple roles. For example, it is possible for the the same additive both to help reduce fluid loss and help create a stress cage across the open fractures in a formation. In fact, some materials, when used as an additive at significantly different particle sizes and shapes, can function predominantly either as a fluid loss control agent or as a bridging agent, without any change in composition or inherent properties.

Drilling fluid additives have been used for many years in order to enhance fluid loss control and/or to strengthen a wellbore in the drilling (and/or sometimes also in the completion and/or workover) of oil and/or gas wells. Our invention can be described most clearly, and hence it can be taught most effectively, by first providing a broad overview of the relevant literature, with emphasis on the more recent developments involving the development of mechanical approaches to wellbore strengthening.

The following discussion of the relevant literature will be subdivided into two subsections. The scientific literature regarding the use of drilling fluid additives in fluid loss control and wellbore strengthening will be reviewed first. The patents that appear to be most closely related to the field of the invention will then be reviewed.

### B. Scientific Literature

The vast majority of the most interesting scientific literature in this field was published, and continues to be published, in the conference proceedings of the following three professional societies: SPE (Society of Petroleum Engineers), IADC (International Association of Drilling Contractors), and AADE (American Association of Drilling Engineers).

Dobson et al. (1998) reviewed developments in particle selection and sizing from a historical perspective. In summary, work involving the development of optimum additives and particle size distributions for the control of filter cake thickness and permeability and for the reduction of fluid loss has been going on since as far back as the 1930s. The earliest useful definitions of a proper particle size distribution for a fluid loss control additive go back to the 1950s. It was recognized as far back as in the 1960s that it is useful to have an overlapping particle size distribution providing a continuous range from very fine particles to particles coarse enough to bridge the openings of a porous formation. These ideas were refined in the 1970s to show that the optimum particle size distribution can be optimized for given formation to include particles ranging from colloidal size (under 2 microns in diameter) to roughly the size of the fracture opening. It was also shown in the 1960s and 1970s that optimized concentrations and particle size distributions of some acid-soluble salts (especially as calcium carbonate) and some water-soluble salts (especially sodium chloride), which can be obtained over a very wide range of particle size distributions (from colloidal up to several millimeters in diameter) by using different grinding procedures and equipment, are very useful both in providing the primary bridge across the fracture and in plugging the interstices between the primary bridging particles to create a tight filter cake of low permeability. The importance of rheology control and of the eventual ease of removing the filter cake as factors that need to be considered in additive package design were also recognized a long time ago.

Fuh et al. (1992) was a landmark publication which introduced explicitly the general concept of wellbore strengthening. Implementations of this concept involved the enhancement of formation fracture resistance by using loss prevention materials in drilling fluids, to reduce or prevent lost circulation during drilling. The theoretical aspects were formulated and presented in their early forms. Field test results (where ground nut shells and calcined petroleum coke are used as the granular loss prevention additives) demonstrated the inhibition of fracture initiation and growth when implementing this approach with water-based muds, resulting in the possibility of using it beneficially in practice. Laboratory tests showed that this approach also works when using oil-based muds, where mud lost to the formation can be very expensive, unsafe (due to the possibility of underground blowout), and time consuming to remedy. The importance of the size range distribution of the granular material used to reduce lost circulation was also emphasized.

Many articles published by authors affiliated with British Petroleum refined the theory and practice of the wellbore strengthening approach. Highlights from some of these articles will be summarized in this paragraph. (a) Alberty and McLean (2001) addressed the challenges of drilling wells in late reservoir life, where a reservoir may be severely depleted. They discussed the theories on fracture gradients and the reasons for their differences. They also provided field examples supporting a more optimistic approach to the drilling of depleted reservoirs. (b) Aston et al. (2002) described their work towards the development of zero fluid loss oil-based drilling muds. The main focus was on an experimental study which probed the function of common additives such as barite and clays, dispersed liquid (the emulsion phase), and materials such as asphalts, gilsonites and polymers. Within the range of compositions that they probed, they found that three critical mud components (fine clay, emulsion droplets, and partially soluble additives such as gilsonites or certain polymers) were required to achieve extremely low fluid loss. (c) Aston et al. (2004) discussed the development of “designer muds” for wellbore strengthening. Such muds effectively increase the fracture resistance while drilling, and can be applied both in shale and in sandstone. In this approach, small fractures are allowed to form in the wellbore wall and held open by using bridging particles near the wellbore opening. The bridge must have a low permability that can provide pressure isolation. Provided that the induced fracture is bridged at or close to the wellbore wall, this method creates an increased hoop stress around the wellbore, which the authors referred to as the “stress cage” effect. The aim, in producing a “designer mud”, is to be able to achieve this effect continuously furing drilling by adding appropriate materials to the mud system. The challenges of implementing this approach in drilling through permeable rocks and through rocks of low permeability were discussed. Laboratory testing data and field test results were presented. Calcium carbonate bridging solids were used in some of their experiments, while other experiments involved the use of blends of calcium carbonate and graphite. (d) Alberty and McLean (2004) provided a more quantitative physical understanding of the stress cage concept, showed how finite element simulations can be used to develop drilling fluid systems implementing this concept in specific situations, and demonstrated the quantitative predictability of the sizes and concentrations of the large particles needed to establish a “bridge” across a fracture. (e) Song and Rojas (2006) described developmental work to produce a drilling fluid that strengthens the wellbore while drilling by using this fluid to help implement the concepts of stress cage theory. They emphasized that the accurate calculation of the initial fracture width that needs to be sealed is crucial and is best done by using numerical methods on a case by case basis rather than simple closed-form equations. Two case histories were summarized. (f) Aston et al. (2007) focused on wellbore strengthening in shale. A treatment pill was developed in the laboratory and tested successfully in the field. This treatment consisted of a blend of particulates (which the authors referred to as “stress cage solids”) and proprietary crosslinked gelling polymers which set with time. Blends of marble particles of different size ranges (coarse, medium, and fine) and graphitic particles were used as the bridging (stress cage) solids. The properties of the system (such as compressive strength, adhesion to shale, and the sensitivity to temperature and pressure) were evaluated. Modeling was performed to engineer the size and concentration of the required bridging solids.

Aadnoy and Belayneh (2004) developed an elasto-plastic fracturing model for wellbore stability using non-penetrating fluids and showed that this model fits well to the results of fracturing experiments that were performed in the laboratory. Aadnoy et al. (2007) addressed the design of well barriers to combat circulation losses. In testing commercial lost circulation materials (coarse and fine calcium carbonates, medium and fine polymers, graphite, medium and fine micas, cellulose, and feldspar), they found that some worked well, some worked poorly, and some worked only in synergy with others. One result was that calcium carbonate can be replaced with more efficient materials. The creation of a stable bridge required the largest particle diameter to be equal to or larger than the fracture width. Adding small amounts of carbon fibers had a positive effect if the lengths of these carbon fibers exceeded the fracture width, as the carbon fibers built the first bridges in a first fracture and thus provided initial support for smaller particles that eventually formed a barrier. At least a minimum particle concentration was found to be required to provide sufficient bridging material.

Gonzales et al. (2003) showed that the incorporation of a small amount of a mixture of medium and coarse highly anisotropic (platelet-shaped) flakes of calcium carbonate into the drilling fluid formulation results in lower high-pressure high-temperature (HPHT) spurt loss and lower total HPHT filtrate volume in laboratory tests, and provides performance improvements in field tests. The role of the highly anisotropic particles was described as the further enhancement of bridging. The incorporation of an oil-soluble styrene-butadiene copolymer into the formulation (as an alternative to gilsonite or asphalt) was shown to result in reductions in formation damage, also as assessed by laboratory testing and field studies.

Quintero and Jones (2004) reported that the proper selection of surfactants and polymers, together with the use of unique bridging material selection methods, enables the design of highly thixotropic drill-in fluids that exhibit optimal filtration properties, excellent crude oil/drill-in fluid compatibilities, and high return permeability. They described the development of a water-based drill-in fluid stabilized by a specially selected polymer-surfactant complex, containing bridging materials designed specifically for low pressured sandstone and carbonate reservoirs. It was shown that the use of a bridging material where granular shapes from conventionally ground calcium carbonate are mixed with a unique flaked calcium carbonate improves spurt loss and filter cake development in both low-pressure and high-pressure environments relative to the use of only the granular form of calcium carbonate.

Tehrani et al. (2007) both reviewed the stress cage technology in the broader context of drilling in depleted zones and presented original data (three examples of laboratory experiments, one case history) illustrating the design and usefulness of drilling fluid additive packages for the implementation of the stress cage concept. Coarse, medium and very fine grades of calcium carbonate, fine cellulosic fibers, fine crushed nut shells, and blends of graphite with industrial carbon, were used as additives in various experiments. They used simulation software to develop successful optimum additive size distributions. The use of a substantial and carefully selected amount of very large particles was crucial for the successful implementation of the stress cage concept, with the optimum detailed particle size distribution varying in a predictable and calculable manner as a function of several factors. It was also shown to be important to select the type and concentration of particles carefully; such that the right balance can be achieved between propping induced fractures of a critical size, minimizing fluid loss into a fracture to prevent fracture propagation, and maintaining favorable fluid rheology. In work from the same group, Friedheim and Tehrani (2007) focused mainly on the description of the testing devices that were set up to run the laboratory experiments.

Kaageson-Loe et al. (2008) used a blend of graphite and crushed nutshells to investigate the interplay between the particle size distributions of loss prevention materials, fluid loss, and formation permeability, in the plugging and sealing of fractures. Their data showed the importance of having a significant percentage of particles that are larger than the fracture aperture in order to produce the most competent fracture seals that are capable of withholding high mud pressures. It also appeared that, once the foundations of the seal are established, the speed with which an effective pressure seal is established may be primarily controlled by the relative concentration of the finer fraction in the particle size distribution.

Hansen et al. (2006) addressed the challenges of drilling highly directional wells in a subsea HPHT reservoir (offshore mid-Norway, in the Norwegian Sea) while dealing with harsh environmental conditions (such as extreme cold during winter). Three different drilling fluid systems [Cs/K—COOH clear brine system, invert emulsion HPHT OBM, and invert emulsion HPHT OBM with ultrafine (micronized barite) weighting particles] were compared. The addition of particles to strengthen the borehole wall and/or filter cake to create a stress cage was an approach that was pursued by using a certain distribution of calcium carbonate and graphite.

Davison et al. (2004) described work performed at the severely depleted Brent reservoir to extend the drilling operating window. A task force set about finding possible solutions to combat the lost circulation problems. It recommended that a size and concentration of graphite should be added to the oil-based mud. Significant improvements (on the average, approximately 88% reduction in mud losses, 1000 psi increase in fracture breakdown pressure, and decrease of unproductive time associated with mud losses from 302 hours to less than 1 hour per well) were observed with the addition of the graphite in field tests.

Siddiqui et al (2006) developed less damaging water-based drill-in fluids for use in multilateral maximum reservoir contact wells in a newly developed field in Saudi Arabia. They optimized the loading and particle size distribution of fine and medium-sized particles of calcium carbonate with fairly fixed median particle size in order to reduce fines and polymer plugging. The optimum ratio of fine to medium-sized calcium carbonate was found to be 35:65 (8:15 ppb fine:medium) in 23 ppb bridging material loading. Tests in the laboratory on reservoir cores using a dynamic mud flow loop system at stimulated reservoir conditions resulted in 80% return permeability for the optimized fluids. Use of the optimized fluids in the field showed major increases in productivity. It was also emphasized that the neglect of the quality of the drill-in fluid during drilling (failure to monitor its particle size distribution and other properties and take appropriate action to remedy declines in quality), resulting in the reduction of the median particle size via crushing of particles during drilling as well as in an increased solids content of the fluid, is one of the reasons for possible formation damage as manifested by permeability reductions.

One major drawback to the practical use of graphitic materials in many drilling situations has been their loss at the surface over solids control equipment that is a part of the drilling fluids circulating system. Too coarse a screen would allow more of the graphite to remain in the drilling fluid, but at the same time allow more drill solids to be retained in the fluid system. Too fine a screen would discard too much of the graphitic materials, raising costs and complicating addition logistics. As a compromise, a 40-mesh screen has become a commonly used optimum screen size. A Graphite Recovery System was developed by van Oort et al. (2007) as a major step towards overcoming this practical limitation to the maintenance of the quality of drilling fluids containing graphitic materials. This system can be viewed as a novel and highly sophisticated mechanical method of recovery. The ability of a sized material to resist degradation while undergoing mechanical shearing during the process is important for the ability to implement this approach successfully. It was shown in laboratory experiments that sized graphite particles possess good resistance to degradation under shear (almost as good as sized cellulose particles), while sized calcium carbonate is highly susceptible to mechanical degradation due to its relative softness. Hence this process (and other similar processes) would be expected to work well for sized graphite and sized cellulose particles, but not for sized calcium carbonate particles. Favorable initial results obtained in field trials were summarized.

Suri and Sharma (2004) indicated that, in order to minimize formation damage caused by drill-in and completion fluids, solids must be large enough not to invade the rock and small enough to form filter cake that effectively filters drill solids and polymers from entering the formation. These criteria, when used together with the model that they presented, were shown to determine quantitatively the particle size distribution that should be used in drill-in fluids for a given formation permeability, overbalance pressure, and mud formulation. The equations of the model were implemented in a Visual Basic program named UTDAMAGE that can be used to design and evaluate fluids for minimum formation damage. The predictions of the model were shown to agree well with the results of mud filtration experiments.

Adachi et al. (2004) described an approach that links a fracture-fluid-flow model with fluid rheology over a wide range of flow rates and flow behavior in a fracture generation apparatus. The understanding gained was used to develop guidelines for minimizing losses into fractures. The effect of fluid rheology on fluid loss rate was demonstrated under various combinations of the parameters relevant to depleted zone drilling, with emphasis on graphitic materials in the experimental portion of the article.

Dupriest (2005) reviewed the rock mechanics perspective on lost returns mitigation. It presented the resulting Fracture Closure Stress Practices, a Treatment Selection Guide that operators can use the implement these Practices, an overview of worldwide results obtained by ExxonMobil, and discussions of the key factors that limit the performance in some situations.

Soroush and Sampaio (2006) provided an excellent broad literature review of existing formation strengthening methods and their relative effectiveness (advantages and disadvantages) for use in strengthening fractured formations.

Vickers et al. (2006) described what appears, to our knowledge, to be the best method available as of mid-2008 for predicting the optimum bridging particle size distribution to seal, in an efficient manner, a varied pore throat distribution as found in natural reservoir formations. Natural reservoir formations tend to have a spread of pore diameters. When formulating a non-damaging reservoir drill-in fluid, technicians typically consider either the mean reservoir pore diameter or a linear relationship of the largest pore diameters down to zero. However, actual pore throat measurements indicate that these are poor ways to describe the size distribution of the pore openings found in natural reservoirs and hence inefficient design criteria to select the bridging particles required to seal them quickly and effectively. This paper presented a new method for predicting the most efficient way to create a particle bridge on a formation face having a wide spread of pore throat sizes. In summary, mercury injection data (which can be obtained during the same process that is used to measure the reservoir core permeability) were analyzed to obtain an accurate description of the pore throat distribution in a reservoir. A more efficient method of bridging control was devised by using these data. This new method involved selecting five target particle sizes, based on the measured pore throat distribution, that must be matched separately by the bridging particles in order to create a “jamming effect” (tight pack) where ideal packing is approached by achieving the bridging and/or filling of both fracture openings and interparticle gaps of all sizes: D90 (<largest pore throat), D75 (<⅔ of the largest pore throat), D50 (±⅓ of the mean pore throat), D25 ( 1/7 of the mean pore throat), and D10 (>smallest pore throat). Laboratory and field tests showed that the use of bridging particle distributions selected by utilizing this new method resulted in improvements over the use of the previously developed particle size distribution selection methods. It was also concluded that the new method works well with both oil-based muds and water-based muds.

Vickers et al. (2007) discussed the application of specially formulated bridging materials to reduce pore pressure transmission and thus enable depleted fractured reservoirs to be drilled and produced without incurring formation damage. For this purpose, the efficient control of filter cake deposition was desired during drilling, along with a filter cake that can be disrupted easily later when a well is backflowed during production. According to earlier work reviewed fairly extensively in the first half of the article, the following had already been established: (1) An especially effective formulation contains three types of additives in optimized combinations; namely, sized calcium carbonate, powdered graphite, and a micronized deformable polymer dispersion in water. (2) The following roles had been ascribed to these three types of additives and had been found to combine synergistically: (a) The sized calcium carbonate assists in bridging pore throats and small fractures, increasing the speed at which a filter cake can be formed and also helping to reduce the overall cost of the treatment by reducing the required concentration of graphite. (b) The addition of graphite strengthens the reservoir rock, enabling it to remain stable despite an overbalance beyond the point at which physical failure had previously occurred in offset wells. The deformability of graphite provides a major advantage in this context. Graphite deforms under pressure and can thus change from its original shape and powdered state to fill the pores and thus create a much more effective pressure seal in the throats of fractures, hence preventing fracture propagation and subsequent failure. (c) The deformable polymer forms a thin layer, reducing fluid loss to a minimum and further minimizing the pore pressure transmission. (3) The resulting synergy enables a large range of fracture sizes to be bridged, and also allows the sealing of fractures that change in dimension as downhole pressures are altered during the drilling process. The greatest wellbore strengthening is obtained when all three types of additives are present in the formulation. By contrast, if only sized calcium carbonate and powdered graphite are used and the deformable polymer is left out of the formulation, then while major improvements are still obtained relative to the use of sized calcium carbonate by itself the wellbore strengthening is not as high as that provided by the use of all three of these additives. In the new work described in the article, the concept of applying graphite for borehole strengthening was investigated further to ensure that the application is nondamaging despite the fact that graphite is extremely inert and insoluble in even strong acids so that it cannot be removed by an acid wash. It was indicated that, when powdered graphite is put under pressure, it will deform to a solid mass and then will return to its initial powdered state when the pressure is released. If this reversible process happened to the graphite in fractures or pore throats in a reservoir, it should be easily backflowed, resulting in low potential to reduce return permeability. The additional fluid loss additive (a micronized deformable polymer dispersion in water) was replaced by sulfonated asphalt whose use is not limited to water-based muds as it can also be used in oil-based muds. An oil-based mud was used in both the laboratory experiments and the field studies in a North Sea reservoir. The formulations that were tested included those where (a) sized calcium carbonate, powdered graphite and sulfonated asphalt were all present; (b) only sized calcium carbonate and powdered graphite were present; and (c) only sized calcium carbonate and sulfonated asphalt were present. The maximum benefits in terms of the reduction of filtrate loss and drastic reduction of pore pressure transmission were observed when all three additives were present. There was no detrimental effect of graphite on the return permeability in tested reservoirs. Ready backflow of graphite out of pore throats and fissures was observed when the overbalance pressure was reduced. The removal of graphite (leaving only calcium carbonate and sulfonated asphalt) had a severely detrimental effect on filtrate control (resulting in much greater fluid loss) as well as on the return permeability. The removal of sulfonated asphalt (leaving only calcium carbonate and graphite) had a detrimental effect on the return permeability.

El-Sayed et al. (2007) described the drilling of wells in the Nile Delta (Egypt) under very difficult conditions where lost circulation control was a major hurdle. They found that a single approach to resolving lost circulation problems did not apply to every well and that it was better to develop treatments that were custom-designed for each situation. A “dual action”, expansive lost circulation material was able to cure losses and allow well completion cost-effectively in some very challenging situations. This proprietary blend consisted of multiple-sized particles to enhance fracture tip screenout, and a synthetic polymer which hydrates and swells up to 400 times its original volume in water as a function of time and temperature.

Gil et al. (2006) proposed the use of wellbore cooling, in combination with more classical strengthening processes, to permanently increase the fracture gradient without the risk of circulation losses inherent in the stress cage method as it is currently applied. The technical challenge that they were trying to overcome was that of creating effective stress cages in formations of low permeability such as shales. It was, however, stated that their method may also be utilized to magnify the effect of “standard” stress cages in permeable formations. Their approach involves lowering the temperature of the drilling mud; thus reducing the hoop stress at the borehole wall and then “setting” the stress cage in the standard manner. Tensile cracks can then be induced at significantly lower mud weights. Given the typical thermal conductivity properties of rocks, the tensile stresses induced by cooling (and consequently, the created fractures) will tend to be confined to the near wellbore region. The magnitude of the temperature change is determined by the required increment in fracture resistance, which also establishes the opening of the fractures in the stress cage. The rock is then allowed to go back to its original temperature. As the formation regains temperature, the tangential stress acting on the fracture faces increases; thus, locking the particles in place along the fracture length. It was proposed that the particle size distribution should be made as wide as possible and that deformable solids such as graphite should be used in order to reduce the permeability of the “bridge” at the fracture entrance. It was stated that the advantage of their new technology is that it broadens the application of the stress cage technique, without creating formation damage. The article contained the results of modeling and simulations to illustrate the promise of the new approach, but did not provide experimental results.

Wu and Hu (2007) described work demonstrating that the use of a low permeability filter cake can limit damage from high-pH drilling fluids. It was shown that changing the particle size distribution of the solid additives in the drilling fluid can be very useful in terms of reducing the filter cake permeability and reducing fluid invasion into wells in a field study, thus enhancing the productivity of these wells. However, details were not provided on the particle size distributions, instead identifying each test by just a sample number.

Gronewald et al. (2001) presented the results of a laboratory evaluation of some lost circulation materials made from the bark of Indonesian trees and used in geothermal drilling operations in Indonesia and the Philippines. The laboratory tests involved the addition of these new materials to a standard water-based bentonite mud containing ground walnut shells. The performance of the muds containing these new additives (in addition to the ground walnut shells) was then compared with the baseline performance provided by the mud containing only the ground walnut shells. Under the test conditions that were used, little or no consistent improvement was found in the bridging and sealing performance relative to the baseline mud containing only the ground walnut shells. These results contrasted with actual field experience which suggested that the addition of the new materials to the drilling mud provides significant improvements in the lost circulation performance. The differences between the laboratory test conditions and the actual field conditions that may have caused the new materials to perform worse in the laboratory than they did in the field were discussed briefly. This report is of general interest because most workers in the field are used to thinking that a laboratory test under carefully controlled conditions will provide better results than a field test where there may be many unidentified and uncontrolled factors. However, in reality, if the laboratory test conditions and equipment are not chosen very carefully, the results of laboratory tests may be worse than what would have been found under field testing conditions, causing the value and usefulness of a new formulation to be underrated.

### C. Patent Literature

U.S. Pat. No. 5,114,598 taught a process for the manufacture of a water-based drilling fluid additive comprising the steps of: (a) premixing hydrophobic asphaltite and either a surfactant or a dispersant; and (b) shearing the mixture of step (a) under a sufficiently high mechanical shear for a sufficient time to convert the hydrophobic asphaltite into hydrophilic asphaltite. This invention was also directed to a water-based drilling fluid additive prepared according to the process of steps (a) and (b) and the use of the additive in a water-based drilling fluid. The BlacKnite™ (trademark of the Sun Drilling Products Corporation) borehole stabilization and HPHT (high-pressure high-temperature) fluid loss control product of the Sun Drilling Products Corporation is covered by U.S. Pat. No. 5,114,598. BlacKnite™ contains multisized particles in a proprietary blend containing coupled uintaite (“gilsonite”), glycol, and surfactant that actually strengthen the well bore minimizing washout and spurt loss. BlacKnite™ is specially blended to offer beneficial particle size distribution additives to the drilling fluid. U.S. Pat. No. 5,114,598 is incorporated herein by reference in its entirety.

U.S. Pat. No. RE35,163 disclosed a water-based drilling mud additive comprising a preblended combination of about 2 parts of high softening point uintaite, about 1 part of a lower softening point uintaite, about 1 part of causticized lignite, and a strongly lipophilic nonionic surfactant. It was claimed that this composition decreases shale sloughing and heaving during the drilling of wells.

U.K. Patent Application No. GB2351098 taught a water-based wellbore fluid, for use in operations such as drilling, fracturing, gravel packing, or workover, and comprising a fluid loss additive and a bridging material that are hydrophobic in nature, hydrophobically modified, or oil wettable. It indicated that the wellbore fluid generates an active filter cake that, once formed, is impermeable to an aqueous phase, thus reducing fluid loss and ensuring reduced damage to the formation, yet simultaneously being permeable to the backflow of hydrocarbons during a hydrocarbon recovery process. Hydrophobically modified starch, polyanionic cellulose, carboxymethylcellulose, or poly(hydroxypropyl methacrylate) were listed as specific materials from among which the fluid loss additive may be selected. Hydrophobically coated carbonates (such as calcium carbonates, zinc carbonates, or barium carbonates); hydrophobically coated metal oxides (such as hematite, ilmenite, or magnesium oxide); hydrophobically coated versions of other particles (such as barite particles, silica particles, clay particles, or microspheres); and crystalline additives of low molecular weight (such as 1-S-endo-Borneol, camphor, iodine, beta carotene, lycophene, cholesterol, lanosterol, or agnosterol) were listed as specific materials from among which the bridging agent may be selected.

U.S. Pat. No. 6,403,537 disclosed a drilling fluid system comprising a brine and a quantity of cationic copolymers comprising a ratio of acrylamide monomers to cationic derivatives of acrylamide monomers, wherein the quantity and ratio are effective to maintain effective rheology and fluid loss control in the drilling fluid system at temperatures of at least about 250° C. for at least about 16 hours. It was indicated that the drilling fluid system preferably also includes bridging agents to bridge the pores in the formation. Ground marble or calcium carbonate particles were provided as examples of preferred bridging agents. It was stated that the preferred calcium carbonate particles have a mean particle size of about 30 microns.

European Patent Application No. EP1074598 and U.S. Pat. No. 6,391,830 provided clay-free, preferably biopolymer-free, well drilling and servicing fluids comprising an aqueous divalent cation-containing water soluble salt, a bridging agent, and a pregelatinized crosslinked amylopectin starch suspending and fluid loss control additive. The combination of Theological (high viscosity at low shear rates, strong shear thinning tendency resulting in low viscosity at high shear rates), low fluid loss, and anti-settling characteristics of these fluids were stated to result in their greater effectiveness as compared with previously developed fluids. Preferred bridging agents have a specific gravity less than about 3.0 and are sufficiently acid soluble that they will readily decompose upon acidizing the filter cake and deposits in the borehole. Calcium carbonate, dolomite (calcium magnesium carbonate), colemanite, ulexite, analcite, apatite, bauxite, brucite, gibsite and hydrotalcite were listed as representative bridging agents.

European Patent Specification No. EP1178099 taught a method of removing filter cake from the walls of a wellbore penetrating a producing formation by using an aqueous cleanup solution. The filter cake was deposited by a drilling or servicing fluid comprising water, a density-increasing water-soluble salt, a fluid loss control agent, a hydratable polymer solids suspending agent, and a particulate solid bridging agent. The particulate solid bridging agent comprised an inorganic compound selected from metal oxides, metal hydroxides, metal carbonates, metal sulfates, metal tungstates, metal fluorides, metal phosphates, metal peroxides and metal fluorosilicates. The use of a particulate solid bridging agent selected from magnesium oxychloride cement, magnesium oxysulfate cement, magnesium potassium phosphate hexahydrate, magnesium hydrogen phosphate trihydrate, or magnesium ammonium phosphate hexahydrate, was disclosed in European Patent Application No. EP1223207, again in the context of methods for removing filter cake by using an aqueous cleanup solution.

U.S. Pat. No. 5,783,527 provided alkaline water-based drilling and servicing fluids which deposit an easily degradable and removable filter cake. These fluids contain one or more polysaccharide polymers, sized bridging particles, and a peroxide. The bridging particles are selected from the group consisting of calcium carbonate, limestone, marble, dolomite, iron carbonate, zinc oxide, and mixtures thereof.

U.S. Pat. No. 7,211,546 provided well drilling and servicing fluids, and methods of drilling, completing or working over a well therewith, wherein the compositions of the preferred fluids comprise sized particulate calcined magnesia (magnesium oxide) bridging solids. It was indicated that, since the optimum particle size distribution of the bridging agent depends on the sizes of the openings in the formations ro be bridged and sealed, it is preferred to have several sized particulate magnesia products having different particle size distributions which can be blended to produce fluids effective in sealing the formations contacted by the fluids.

U.S. Patent Application No. 20070173418 provided fluid loss control compositions comprising ceramic particulate bridging agents, a partially depolymerized starch derivative, and a base fluid. At least a portion of the ceramic particulate bridging agents comprised chemically bonded particulates in some embodiments. In some other embodiments, at least a portion of the ceramic particulate bridging agents were substantially insoluble in water. The particle size distribution of the ceramic particulate bridging agents could be varied depending on the openings to which the bridging agents will be introduced. It was indicated that suitable size ranges were from about 0.1 microns to about 200 microns if pore throats on a portion of a subterranean formation are to be bridged, from about 1 micron to about 1 millimeter for applications such as bridging on a gravel pack, and from about 5 microns to about 8 millimeters when an operation involves sealing on perforations and other openings such as objects having a plurality of holes.

World Patent Application No. WO2005012687 taught a method of reducing formation breakdown during the drilling of a wellbore. This method comprises: (a) circulating a drilling mud in the wellbore comprising (i) an aqueous or oil based fluid, (ii) at least one fluid loss additive at a concentration effective to achieve an HPHT fluid loss of less than 2 ml/30 minutes from the drilling mud, and (iii) a solid particulate bridging material having an average particle diameter of 25 to 2000 microns and a concentration of at least 0.5 pound per barrel; (b) increasing the pressure in the wellbore to above the initial fracture pressure of the formation such that fractures are induced in the formation and a substantially fluid impermeable bridge comprising the solid particulate material and the fluid loss additive(s) is formed at or near the mouth of the fractures thereby strengthening the formation; and (c) thereafter continuing to drill the wellbore with the pressure in the wellbore maintained at above the initial fracture pressure of the formation and below the breakdown pressure of the strengthened formation. Suitable fluid loss additives include organic polymers of natural or synthetic origin and/or finely dispersed particles such as clays. The bridging material comprises at least one substantially crush resistant particulate solid such that the bridging material props open the fractures (cracks or fissures) that are induced in the wall of the wellbore. Preferred bridging materials include graphite, calcium carbonate, dolomite, celluloses, micas, proppant materials such as sands or ceramic particles, and combinations thereof. It is also envisaged that a portion of the bridging material may comprise drill cuttings having the desired average particle diameter in the range of 25 to 2000 microns. The concentration of the bridging material may vary with the drilling mud that is being used and the conditions of use. Suitably, the bridging material is sized so as to readily form a bridge at or near the mouths of the induced fractures.

U.S. Patent Application No. 20060213663 taught a method of servicing a wellbore, comprising providing a carrier fluid and a resilient material, and introducing the wellbore fluid to an annulus, wherein at least a portion of the resilient material reduces in volume when exposed to a compressive force to affect the annular pressure. The resilient material is able to return back to about its normal volume (in other words, to its volume prior to the application of a compressive force) when the compressive force subsides. The resilient material comprises a natural rubber, a synthetic rubber, another elastomeric material, an expanded polystyrene (such as Styrofoam™) bead, a graphite, a polymeric bead, or combinations thereof. The use of some commercially available resilient graphites in this application was illustrated in an example.

U.S. Pat. No. 7,331,391 teaches a method of preventing or treating lost circulation, comprising the addition of water-dispersible fibers (such as glass fibers or polymer fibers) having a length between about 10 mm and about 25 mm, to a pumped aqueous base fluid including solid particles having an equivalent diameter of less than 300 microns. The solid particles are selected from the list consisting of barite, hematite, ilmenite, calcium carbonate, iron carbonate, lead sulfide, manganese tetroxide, zinc oxide, dolomite, cement, and mixtures thereof It is stated that the water-dispersible fibers appear to enhance the formation of a filter cake by forming a mesh along the borewall that easily plugs with the small solid particles.

World Patent Application No. 2007088322 relates to a wellbore fluid comprising a base fluid and a particulate bridging agent comprised of a sparingly water-soluble material selected from the group consisting of melamine, lithium carbonate, lithium phosphate, and magnesium sulfite, preferably, melamine and lithium carbonate.

### SUMMARY OF THE INVENTION

### A. Additive Packages Comprising Thermoset Nanocomposite Particles

In one aspect, our invention relates to the use of thermoset nanocomposite particles as components of drilling fluid, drill-in fluid, completion fluid, and workover fluid additive packages to reduce fluid losses to a formation and/or to enhance a wellbore strength.

The thermoset nanocomposite particles may be used in any amount that is at least about 0.1 ppb in embodiments of the invention. The unit “ppb” (pounds per barrel) is defined here in accordance with common practice in the industry; namely, relative to a so-called “blue barrel” possessing a volume of 42 gallons.

The thermoset nanocomposite particles used in embodiments of the invention can have a shape selected from the group of shapes consisting of a powder, a pellet, a grain, a seed, a short fiber, a rod, a cylinder, a platelet, a bead, a spheroid, or mixtures thereof, and can possess any suitable size distribution.

The thermoset nanocomposite particles used in embodiments of the invention exhibit excellent stiffness, strength, heat resistance, and resistance to degradation over time in aggressive environments, and are also nonabrasive and lubricious, with this combination of performance characteristics making them especially suitable for use in downhole environments under high compressive loads at elevated temperatures.

Our previous patent applications (U.S. Patent Application Publication Nos. 20070021309, 20070066491, 20070161515, and 20070181302) have covered a broad range of thermoset nanocomposite particle compositions of matter and are incorporated herein in their entirety by reference.

B. Additive Packages Comprising Particles of Specific Gravity Ranging from 0.75 to 1.75

In another aspect, our invention relates to the use particles of specific gravity ranging from about 0.75 to about 1.75 as components of drilling fluid, drill-in fluid, completion fluid, and workover fluid additive packages to reduce fluid losses to a formation and/or to enhance a wellbore strength.

The term “about” will be understood by persons of ordinary skill in the art and will vary to some extent on the context in which it is used. If there are uses of the term which are not clear to persons of ordinary skill in the art given the context in which it is used, “about” shall mean up to plus or minus 10% of the particular value.

The particles of specific gravity ranging from about 0.75 to about 1.75 may be used in any amount that is at least about 0.1 ppb in embodiments of the invention.

The particles of specific gravity ranging from about 0.75 to about 1.75 have a shape selected from the group of shapes consisting of a powder, a pellet, a grain, a seed, a short fiber, a rod, a cylinder, a platelet, a bead, a spheroid, or mixtures thereof, and can possess any suitable size distribution.

Having a specific gravity in the range of about 0.75 to about 1.75 is advantageous because having a particle specific gravity that approaches the specific gravity of a carrier fluid results in the near neutral buoyancy of the particles in that carrier fluid. Among the types of carrier fluids that are used most often, oils typically have specific gravities in the range of about 0.82 to about 0.92, and versions of “slickwater” (water containing various salts and other additives) typically have a specific gravity in the range of about 1.0 to about 1.2. Near neutral buoyancy facilitates the transport of particles to targeted locations in a downhole environment with a decreased tendency to settle during transport.

Without reducing the generality of the invention, it can hence be stated that, within the overall particle specific gravity range of about 0.75 to about 1.75 falling within the scope of the invention, the particle specific gravity subrange of about 0.8 to about 1.25 is often of the greatest practical interest since particles possessing different specific gravities falling within this subrange will manifest near neutral buoyancy in the different types of carrier fluids that are used most frequently.

Our previous patent applications (U.S. Patent Application Publication Nos. 20070021309, 20070066491, 20070161515, and 20070181302) have covered a broad range of compositions of matter for particles of specific gravity ranging from 0.75 to 1.75 and are incorporated herein in their entirety by reference.

### C. Optional Additional Ingredients of Additive Packages of the Invention

Additive packages of the invention, where thermoset nanocomposite particles and/or particles of specific gravity ranging from about 0.75 to about 1.75 are incorporated as ingredients, may optionally contain additional ingredients of any suitable dimensions selected from the group consisting of calcium carbonate, crushed or ground marble, limestone, dolomite (calcium magnesium carbonate), zinc carbonate, barium carbonate, lithium carbonate, iron carbonate, other metal carbonates, hematite, ilmenite, magnesium oxide, manganese tetroxide, zinc oxide, magnesium oxychloride, colemanite, ulexite, analcite, apatite, bauxite, brucite, gibsite, hydrotalcite, other metal oxides, metal hydroxides, magnesium oxysulfate, other metal sulfates, metal tungstates, metal fluorides, lithium phosphate, other metal phosphates, magnesium sulfite, lead sulfide, metal peroxides, magnesium potassium phosphate hexahydrate, magnesium hydrogen phosphate trihydrate, magnesium ammonium phosphate hexahydrate, metal fluorosilicates, sodium chloride, other water-soluble salts, crushed or ground nut shells, crushed or ground seeds, crushed or ground fruit pits, materials obtained from barks of trees, calcined petroleum coke, asphalts, gilsonites, lignites, barite particles, clay particles, mica particles, talc particles, silica particles, sands, feldspar, bauxite particles, ceramic particles, cement particles, melamine, solid or hollow microspheres, graphitic materials, carbon black, other forms of carbon, celluloses, starches, polysaccharides, acrylic polymers, natural rubbers, synthetic rubbers, styrene-diene diblock and triblock copolymers, other natural or synthetic polymers, expanded polystyrene beads, other foam beads, carbon fibers, glass fibers, polymer fibers, other fibers, glycols, water, dispersants, surfactants, thinners, crystalline additives of low molecular weight (such as 1-S-endo-Borneol, camphor, iodine, beta carotene, lycophene, cholesterol, lanosterol, or agnosterol), and combinations thereof In one such embodiment, the thermoset nanocomposite particles and/or particles of specific gravity ranging from about 0.8 to about 1.25.

As was reviewed in the BACKGROUND section, most of the optional additives listed in the paragraph above have already been used or at least considered for use by other workers in additive package formulations. The use of any of the additives listed above is not, therefore, by itself an aspect of the present invention. It is only the optional use of any of the additives listed above in additive package formulations comprising thermoset nanocomposite particles and/or particles of specific gravity ranging from about 0.75 to about 1.75 that is an aspect of the present invention.

### D. Preparation of Additive Packages of the Invention

### 1. Selection of Particle Size Distributions

The criteria and methods for selecting suitable size distributions for particles to be used in additive packages intended for fluid loss control and/or wellbore strengthening are known to workers of ordinary skill in the field of the invention. These criteria and methods are not aspects of the present invention. Any particle size distribution, selected by means of any available criteria and methods, can be used in embodiments of the invention.

In order to facilite the teaching of the invention, and without restricting the generality of the invention, some non-limiting examples of approaches for the selection of the particle size distribution for use in an additive package of the invention will be summarized below.

The optimum particle size distribution depends on the details of the geological formation where a drilling, drill-in, completion, or workover operation is to be performed. These details include the properties and morphology of the geological formation (such as, but not limited to, its chemical composition, rigidity, porosity, and permeability; and whether natural fractures are present before fractures are induced by the operation), as well as the dimensions (and especially the widths of openings) of the fractures where fluid loss control and/or wellbore strengthening are desired.

The optimum particle size distribution also depends on the particle properties (such as, but not limited to, particle stiffness, compressive strength, and toughness; and how the particle properties vary as functions of the temperature) that affect the performance of the particles at the temperatures and stress levels existing in a downhole environment.

When the solid particle size distribution is selected in an optimal manner, the distribution contains sufficient quantities each of solid particles that are (a) small enough to form a filter cake possessing low permeability that reduces fluid loss, and (b) large enough to “bridge” across the fracture opening and thus provide wellbore strengthening.

As simple examples of the effective implementation of the concept of bridging across the fracture opening via selection of an optimum particle size distribution, we note that (a) if the width of the fracture opening is about 0.5 millimeters, then some of the particles should have at least one geometrical dimension that exceeds about 0.5 millimeters; and (b) if the width of the fracture opening is about 1 millimeter, then some of the particles should have at least one geometrical dimension that exceeds about 1 millimeter.

The further details of the particle size distribution, including for example whether a monomodal or bimodal distribution may work best, and optimum relative amounts and size distributions to use of particles of different types (and hence possessing different properties) and geometries, can be optimized for different situations to obtain customized additive packages.

Calculations using software implementing empirical, semi-empirical, or theoretical models of fluid loss control and/or wellbore strengthening may be used, and sometimes are actually used, to assist in the selection of optimum particle types and particle size distributions.

### 2. Mixing of Ingredients

Methods and equipment for mixing the components of an additive package together are known to workers of ordinary skill in the field of the invention. These methods and equipment are not aspects of the present invention. The thermoset nanocomposite particles and/or particles of specific gravity ranging from about 0.75 to about 1.75 may be incorporated into embodiments of the invention by using any of the techniques and equipment available for combining such particles with the other ingredients of an additive package.

In order to facilite the teaching of the invention, and without restricting the generality of the invention, some non-limiting examples of types of approaches for the mixing together of the ingredients of an additive package of the invention can be summarized as follows.

In some embodiments, the thermoset nanocomposite particles and/or particles of specific gravity ranging from about 0.75 to about 1.75 are added, with stirring, into a previously prepared additive package already containing the ingredients of the additive package of the invention other than the thermoset nanocomposite particles and/or particles of specific gravity ranging from about 0.75 to about 1.75. In one such embodiment, the thermoset nanocomposite particles and/or particles of specific gravity ranging from about 0.8 to about 1.25.

In some embodiments, a previously prepared additive package already containing the ingredients of the additive package of the invention other than the thermoset nanocomposite particles and/or particles of specific gravity ranging from about 0.75 to about 1.75 is added, with stirring, to the thermoset nanocomposite particles and/or particles of specific gravity ranging from about 0.75 to about 1.75. In one such embodiment, the thermoset nanocomposite particles and/or particles of specific gravity ranging from about 0.8 to about 1.25.

In some embodiments, the thermoset nanocomposite particles and/or particles of specific gravity ranging from about 0.75 to about 1.75 are mixed with other solid particles to be used in the additive package; and this dry mixture is then added, with stirring, into a fluid. In one such embodiment, the thermoset nanocomposite particles and/or particles of specific gravity ranging from about 0.8 to about 1.25.

In some embodiments, the thermoset nanocomposite particles and/or particles of specific gravity ranging from about 0.75 to about 1.75 and other solid particles to be used in the additive package are added separately, either simultaneously or sequentially, with stirring, into a fluid. In one such embodiment, the thermoset nanocomposite particles and/or particles of specific gravity ranging from about 0.8 to about 1.25.

In some embodiments, the thermoset nanocomposite particles and/or particles of specific gravity ranging from about 0.75 to about 1.75 are mixed with other solid particles to be used in the additive package; and a fluid is then added, with stirring, into this dry mixture. In one such embodiment, the thermoset nanocomposite particles and/or particles of specific gravity ranging from about 0.8 to about 1.25.

In some embodiments, the thermoset nanocomposite particles and/or particles of specific gravity ranging from about 0.75 to about 1.75 and the other ingredients of the additive package are added separately, with stirring, into a drilling fluid, drill-in fluid, completion fluid, and workover fluid, and the complete additive package is formed “in situ” within said fluid as a result of the stirring. In one such embodiment, the thermoset nanocomposite particles and/or particles of specific gravity ranging from about 0.8 to about 1.25.

### E. Applications of Additive Packages of the Invention

Using embodiments of the invention, reduction of fluid loss and/or enhancement of wellbore strength may be achieved while working with water-based, oil-based, invert emulsion, or synthetic drilling muds.

Reduced fluid losses to a formation are demonstrated by decreased HPHT loss, decreased fluid loss in a Permeability Plugging Test (PPT), or a combination thereof, measured via procedures recommended by the applicable standards of the American Petroleum Institute (API RP 13B-1, API RP 13B-2), using any testing mode, equipment, and set of test conditions that meet the requirements of these standards, relative to use of the fluid without said additive package.

Enhanced wellbore strength is measured by the fracture breakdown pressure in laboratory or field testing, relative to use of said fluid without said additive package. The development of techniques for the quantitative evaluation of the ability of an additive package to enhance the wellbore strength is an area of considerable ongoing research activity, both in industry and in academic institutions. As of the date of this disclosure, there is no single experimental approach yet that has gained universal acceptance as an industry standard and/or recommended practice. We consider the fracture sealing equipment and experimental techniques for the use of this equipment that were developed recently at FracTech Laboratories to represent the state of the art in the evaluation of wellbore strengthening and have hence adopted this approach as our measure of the wellbore strengthening effectiveness of an additive package. This experimental approach will be described in detail in Subsection D, titled “Fracture Sealing Experiments”, of the section titled “EXAMPLES”.

### BRIEF DESCRIPTION OF THE DRAWINGS

The accompanying drawings, which are included to provide further understanding of the invention and are incorporated in and constitute a part of this specification, illustrate some embodiments of the invention and, together with the description, serve to explain the principles of the invention.

FIG. 1 compares the particle size distributions of a sample of BlacKnite™ (which represents an example of the prior art) and an exemplary embodiment of the invention containing 15 ppb of a full size distribution of FracBlack™ thermoset nanocomposite particles mixed in with BlacKnite™. The entire distribution shifts towards larger particle sizes, and furthermore a second peak (related to the FracBlack™ particles of sizes greater than about 900 microns) appears so that the particle size distribution becomes bimodal.

FIG. 2 shows an exemplary setup used for the high-pressure high-temperature (HPHT) fluid loss experiments.

FIG. 3 shows an exemplary setup used for the permeability plugging test (PPT).

FIG. 4 shows an exemplary setup used for the fracture sealing experiments.

FIG. 5 show how the fracture width is secured during the fracture sealing experiments. The hydraulic ram provides insufficient stiffness, resulting in the lack of control of the fracture width. The reaction bolts overcome this limitation, thus securing the fracture width.

FIG. 6 shows results of fracture sealing experiments, under an injection pressure of 500 psi (3.447 MPa) at a temperature of 140° F. (60° C.) across a tapered fracture possessing a width of 0.5 millimeters at its opening, for the base mud. When the valve is opened for injection, the base mud fails to form a bridge across the fracture opening and exits the cell rapidly.

FIG. 7 shows results of fracture sealing experiments, under an injection pressure of 500 psi (3.447 MPa) at a temperature of 140° F. (60° C.) across a tapered fracture possessing a width of 0.5 millimeters at its opening, for an additive package containing BlacKnite™ by itself (this additive package is an example of the prior art) added at 2% by volume into the base mud. When the valve is opened for injection, this formulation fails to form a bridge across the fracture opening and exits the cell rapidly.

FIG. 8 shows results of fracture sealing experiments, under an injection pressure of 500 psi (3.447 MPa) at a temperature of 140° F. (60° C.) across a tapered fracture possessing a width of 0.5 millimeters at its opening, for an additive package containing 15 ppb of FracBlack™ added to BlacKnite™ (this additive package is an exemplary embodiment of the present invention) added at 2% by volume into the base mud. When the valve is opened for injection, this formulation rapidly forms a bridge across the fracture opening after a small (220 g) leak-off that takes place during bridge formation. Once the bridge is formed, it is stable as shown by the plateau regions in the curves labeled “Mass Exiting Cell (g)” and “Leak-off (ml)” that persist until the injection pressure is ramped up to higher levels in the final stage of the experiment.

### DESCRIPTION OF THE PREFERRED EMBODIMENTS

The following description of the currently preferred embodiments of the invention are provided as illustrative examples, without limiting the full scope of the invention as described in the SUMMARY OF THE INVENTION section and further specified in the claims. A vast number and variety of additional embodiments can be imagined readily by workers of ordinary skill in the field of the invention with the benefit of this disclosure.

Preferred embodiments of the invention use substantially spherical thermoset nanocomposite particles, ranging from about 5 microns to about 10 millimeters in diameter, and possessing a specific gravity ranging from approximately about 1.0 to approximately about 1.25, wherein the matrix is a copolymer of styrene and divinylbenzene, and wherein carbon black particles possessing a length that is less than about 0.5 microns in at least one principal axis direction are incorporated as a nanofiller. Most preferred embodiments of the invention use substantially spherical thermoset nanocomposite particles, ranging from about 5 microns to about 10 millimeters in diameter, and possessing a specific gravity ranging from approximately 1.02 to approximately 1.15, wherein the matrix is a terpolymer of styrene, ethylvinylbenzene and divinylbenzene, and wherein carbon black particles possessing a length that is less than about 0.5 microns in at least one principal axis direction are incorporated as a nanofiller. The advantage of most preferred compositions over the preferred compositions is the lower total monomer cost which translates into a lower product cost at comparable performance.

A substantially spherical particle is defined as a particle having a roundness of at least about 0.7 and a sphericity of at least about 0.7, as measured by the use of a Krumbien/Sloss chart using the experimental procedure recommended in International Standard ISO 13503-2, “Petroleum and natural gas industries—Completion fluids and materials—Part 2: Measurement of properties of proppants used in hydraulic fracturing and gravel-packing operations” (first edition, 2006), Section 7, for the purposes of this disclosure.

The preparation of the substantially spherical particles used in the preferred or most preferred embodiments of the invention involves suspension polymerization followed by a post-polymerization process step where the particles are postcured by heat treatment.

The substantially spherical particles are used in an amount ranging from about 1 ppb to about 75 ppb in preferred embodiments and in an amount ranging from about 5 ppb to about 40 ppb in most preferred embodiments of the invention. In one such embodiment, the substantially spherical particles are substantially spherical thermoset nanocomposite particles.

In preferred and most preferred embodiments of the invention, the substantially spherical particles range from about 10 microns to about 4000 microns (4 millimeters) in diameter. In one such embodiments, the substantially spherical particles range from about 100 microns to about 1000 microns. In another such embodiments, the substantially spherical particles range from about 500 microns to about 1000 microns. Their total amount of incorporation into an additive package as well as their detailed size distribution can be selected to obtain the optimum fluid loss reduction and/or wellbore strengthening performance. In one such embodiment, the substantially spherical particles are substantially spherical thermoset nanocomposite particles.

In order to facilitate the teaching of the invention without restricting its generality, we note that, in general, the size distribution of the substantially spherical particles in its preferred and most preferred embodiments tends to be shifted to the right (larger particle sizes) compared with the size distributions of the other types of solid particles also included in the additive package.

Again to facilitate the teaching of the invention without restricting its generality, we note that, in one particular embodiment, substantially spherical particles ranging from about 40 microns to about 2000 microns (2 millimeters) in diameter were incorporated at a concentration 15 ppb, while the sizes of the other solid particles that were also included in the same non-limiting example ranged from about 0.5 microns to about 720 microns, resulting in a bimodal overall particle size distribution. In one such embodiment, the substantially spherical particles are substantially spherical thermoset nanocomposite particles.

Again to facilitate the teaching of the invention without restricting its generality, we note that, in the preferred and most preferred embodiments of the invention, the substantially spherical particles are mixed with stirring into a previously prepared additive package already containing the ingredients of the additive package of the invention other than the substantially spherical particles.

Exemplary substantially spherical particles used to demonstrated the most preferred embodiments of the invention are available commercially, under the product names of LiteProp™ 108 (trademark of the BJ Services Company) from the BJ Services Company in the United States of America and FracBlack™ (trademark of the Sun Drilling Products Corporation) from the Sun Drilling Products Corporation elsewhere in the world.

Other ingredients that are often used in the preferred or most preferred embodiments of the invention include gilsonite particles, lignite particles, carbon black particles, a glycol, and a surfactant. The relative amounts of the substantially spherical particles, gilsonite particles, lignite particles, carbon black particles, glycol and surfactant; the particle size distributions of the substantially spherical particles, gilsonite particles, lignite particles, and carbon black particles; and the choices of glycol and surfactant, can all be varied to prepare different preferred or most preferred embodiments of the invention that may work better in different fluid loss control and/or wellbore strengthening applications.

### EXAMPLES

Some non-limiting examples of preferred embodiments of the fracture stimulation method of the invention will now be given, without reducing the generality of the invention, to provide a better understanding of some of the ways in which the invention may be practiced. Workers of ordinary skill in the field of the invention can readily imagine many additional embodiments of the invention with the benefit of this disclosure.

Samples of BlacKnite™ and of a mixture containing about 15 ppb of the full size range of FracBlack™ thermoset nanocomposite particles added to BlacKnite™ were prepared at the facilities of the Sun Drilling Products Corporation, in Belle Chasse, La., USA. BlacKnite™ contains gilsonite particles, lignite particles, and carbon black particles, but lacks thermoset nanocomposite particles, and hence represents the prior art. The sample containing the FracBlack™ thermoset nanocomposite particles added to BlacKnite™ is an exemplary embodiment of the present invention. These samples were shipped to FracTech Laboratories, Surrey, United Kingdom, where all of the tests described below were conducted.

### A. Wet Sieve Analysis

### 1. Experimental Procedure

The required sieves are cleaned (ensuring all loose particles, resin or dust is removed), dried and weighed. The weight of each sieve is recorded on the sieve analysis work sheet. The sieves are stacked firmly together with the lowest ASTM size at the top and the largest at the bottom sitting on the base pan. An approximately 4 g sample of the slurry is dispersed into 1 liter of deionized water.

The dispersed slurry is then poured into the top sieve of the stack and the lid placed on the top sieve ensuring that the lid has its ‘o’ ring in place and it is pushed onto the sieve firmly. The sieves are now placed under flowing water for 10 minutes. After 10 minutes the sieves are individually collected, dried and weighed to determine the weight of product collected at each size. These weights are recorded on the worksheet.

The weight of particles collected at each sieve is calculated and reported as a percentage of the new total weight.

### 2. Results

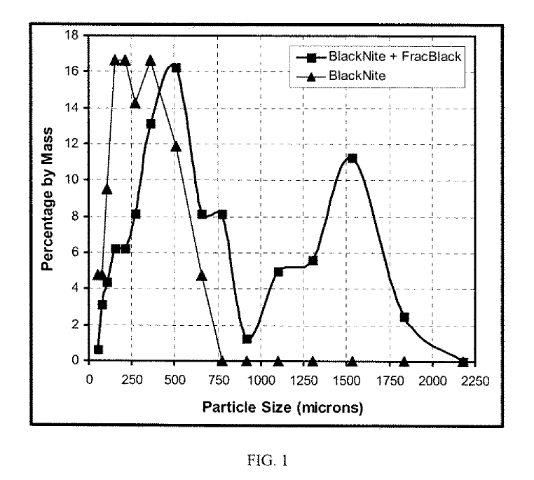

TABLE 1 lists and FIG. 1 compares graphically the particle size distributions of a sample of BlacKnite™ (which represents an example of the prior art) and an exemplary embodiment of the invention containing about 15 ppb of the full size range of FracBlack™ thermoset nanocomposite particles added to BlacKnite™. Upon incorporation of FracBlack™ particles, the entire distribution shifts towards larger particle sizes, and furthermore a second peak (related to the FracBlack™ particles of sizes greater than about 900 microns) appears so that the particle size distribution becomes bimodal.

TABLE 1
Particle size distributions of a sample of BlacKnite ™ (which represents
an example of the prior art) and an exemplary embodiment of the
invention containing 15 ppb of the full size range of FracBlack ™
thermoset nanocomposite particles added to BlacKnite ™.

| | | Percentage | Percentage by Mass in |
|---|---|---|---|
| ASTM Mesh | Average Size | by Mass | BlackNite ™ Modified |
| Size Range | (microns) | in BlackNite ™ | By 15 ppb FracBlack ™ |
| ,−8 + 10 | 2180 | 0.0 | 0.0 |
| ,−10 + 12 | 1835 | 0.0 | 2.5 |
| ,−12 + 14 | 1535 | 0.0 | 11.3 |
| ,−14 + 16 | 1300 | 0.0 | 5.6 |
| ,−16 + 18 | 1100 | 0.0 | 5.0 |
| ,−18 + 20 | 920 | 0.0 | 1.3 |
| ,−20 + 25 | 775 | 0.0 | 8.1 |
| ,−25 + 30 | 655 | 4.8 | 8.1 |
| ,−30 + 40 | 512 | 11.9 | 16.3 |
| ,−40 + 50 | 362 | 16.7 | 13.1 |
| ,−50 + 60 | 275 | 14.3 | 8.1 |
| ,−60 + 80 | 216 | 16.7 | 6.3 |
| ,−80 + 120 | 153 | 16.7 | 6.3 |
| ,−120 + 170 | 108 | 9.5 | 4.4 |
| ,−170 + 230 | 77 | 4.8 | 3.1 |
| ,−230 + 325 | 54 | 4.8 | 0.6 |

Customized preferred embodiments of the invention with different particle size distributions can be obtained, for example, by changing the amount and/or the sieve cut of the incorporated FracBlack™ particles.

### B. High-Pressure High-Temperature (HPHT) Fluid Loss

### 1. Experimental Procedure

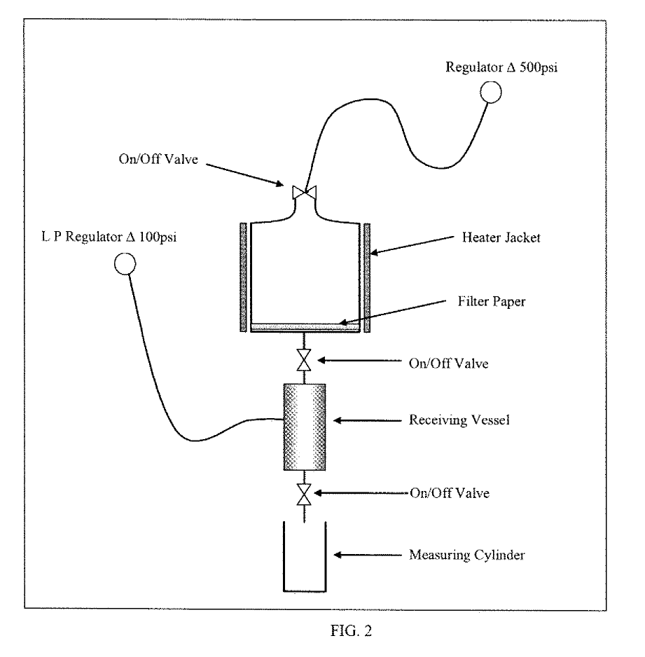

FIG. 2 shows the setup used for the HPHT fluid loss experiments. The main equipment components are the HPHT cell, filtrate collector, heating jacket, pressure regulators, relief valves, and associated pipework. Heating occurs via electrical jacket.

The cell is loaded as follows: (a) Ensure that all parts of the cell are clean prior to use. (b) Ensure that the cell inlet valve is closed and place the cell upside down in the cell holder. (c) Pour approximately 50 ml of the test fluid into the cell. It is essential for the cell not to be completely full of fluid (in other words, the cell must not be in a hydraulic state). (d) Place one disk of 3.5 square inch Whatman 50 filter paper into the top of the cell and an “O” ring. (e) Locate the cell outlet valve (ensuring the valve is open) and screw down the three hexagon screws. (f) Close the cell outlet valve.

Once the cell has been loaded, the measurements are made as follows: (a) Pre-heat the heating jacket by turning on the control switch next to the cabinet. Set the desired temperature (≦150° C.) with the controller dial. The standard test temperature is 121° C. (250° F.). (b) Turn the cell the right way up and place the cell into the heating jacket ensuring that it is properly located. (c) Fit the high-pressure inlet regulator to the top of the cell (the retaining ring must be pulled down). Fit the low pressure outlet regulator (filtrate collector) to the bottom of the cell (the retaining ring must be twisted to the front). (d) Increase the pressure on the inlet regulator to 200 psi, and the pressure on the outlet valve to 100 psi. (e) Open the inlet valve of the cell. Fit a thermocouple into the hole in the top of the cell. Allow the cell to heat up for one hour. (f) At temperature, carefully increase the pressure on the inlet regulator to 600 psi (500 psi differential pressure). Open the outlet valve of the cell. Begin timing the experiment (g) Collect the filtrate over a 30 minute period, then close the outlet and inlet valves of the cell.

The base mud formulation used in this work is listed in TABLE 2. This mud was hot rolled for 16 hours at a temperature of 140° F.

TABLE 2
The base mud formulation used in this work is listed below.
This mud was hot rolled for 16 hours at a temperature of 140° F.

| INGREDIENT | AMOUNT (grams) |
|---|---|
| Clairsol 370 (base oil) | 366 |
| Versamul NS | 8 |
| Versacoat HF | 8 |
| Lime | 10 |
| Versagel HT | 8 |
| Ecotrol | 6 |
| Water | 116 |
| CaCl₂ | 34 |
| HMP Clay (simulated drill solids) | 20 |
| Barite | 260 |

### 2. Results

The results of the HPHT filtrate test at a temperature of 250° F. (121° C.) under a differential pressure of 500 psi (3.447 MPa) are listed in TABLE 3. In accordance with common practice, as shown, in obtaining the final reported results, the measured numbers were multiplied by 2 to normalize for the use of a 3.5 square inch (rather than 7.1 square inch) filter paper.

An additive package consisting of a mixture containing 15 ppb of the full size range of FracBlack™ thermoset nanocomposite particles added to BlacKnite™ (an embodiment of the invention), when used at 2% by volume, lowers the HPHT filtrate volume measured after 30 minutes from 2.8 ml for the base mud to 2.4 ml for the mud containing this additive package.

The use of 2% by volume of BlacKnite™ by itself lowers the HPHT filtrate volume measured after 30 minutes to an even greater extent, down to 2 ml, because of the different main roles played by BlacKnite™ and FracBlack™ particles. BlacKnite™ comprises relatively small particles with a size distribution that is optimal for reducing the HPHT filtrate volume through filter paper. The much larger particles in FracBlack™, which will be shown below to be crucial for wellbore strengthening via fracture bridging, are not as effective as the smaller particles in BlacKnite™ for the purpose of reducing the HPHT filtrate volume going through the filter paper, so that the use of BlacKnite™ by itself results in the lowest HPHT filtrate volume.

TABLE 3
Results of HPHT filtrate tests at a temperature of 250° F.
(121° C.) under a differential pressure of 500 psi (3.447 MPa).
BlacKnite ™ or a mixture containing 15 ppb of the full size
range of FracBlack ™ thermoset nanocomposite particles
added to BlacKnite ™ were incorporated at 2% by volume
into the base mud in the tests evaluating their effects as additives.

| | | | Base Mud + |
|---|---|---|---|
| | | Base Mud + | BlacKnite ™ + |
| | Base Mud | BlacKnite ™ | FracBlack ™ |
| Time (min) | Volume (ml) | Volume (ml) | Volume (ml) |
| 1 | 0.2 × 2 = 0.4 | 0 | 0.2 × 2 = 0.4 |
| 7.5 | 0.6 × 2 = 1.2 | 0.4 × 2 = 0.8 | 0.8 × 2 = 1.4 |
| 15 | 1 × 2 = 2 | 0.8 × 2 = 1.6 | 0.9 × 2 = 1.8 |
| 30 | 1.4 × 2 = 2.8 | 1 × 2 = 2 | 1.2 × 2 = 2.4 |
| Effluent | Clear | Opaque brown | Opaque brown |

### C. Permeability Plugging Test (PPT)

### 1. Experimental Procedure

The Permeability Plugging Test (PPT) is designed to provide more realistic downhole static filtration measurements than can be made by using the more commonly performed HPHT fluid loss measurements. More specifically, this test is especially useful in predicting how a drilling fluid can form a permeable filter cake to seal off depleted and/or underpressure intervals and help prevent differential sticking. The ceramic (aloxite with 35 micron pore diameter) disks used in this test give a more authentic representation of the filter cake that is actually being developed on the wall of the formation, as they more closely simulate the structure of the formation than does filter paper.

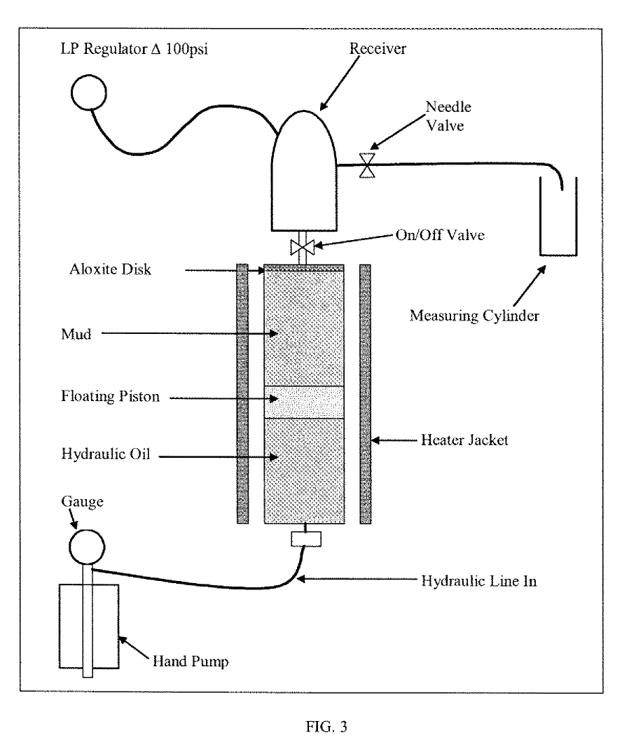

FIG. 3 shows the setup used for the PPT. The main equipment components are the HPHT cell with floating piston, collection vessel, aloxite disks, heating jacket, top pressure regulator, hydraulic oil pump, relief valve and associated pipework. There is a high-pressure nitrogen supply.

The heating jacket is preheated as follows: (a) Connect the power cord to the proper line voltage as indicated on the nameplate (115 V). (b) Turn the thermostat on the heating jacket controller to the desired temperature and turn the unit on. (c) Place a metal stem dial thermometer or thermocouple in the thermometer well of the heating jacket.

The cell is loaded as follows: (a) Check “O” rings on the nipple adapters, the floating piston, cell body and caps. Replace any damaged or brittle “O” rings. (b) Apply a thin coating of vacuum grease completely around the “O” rings of the floating piston, the nipple adapters and the cell end caps. (c) Screw the floating piston onto the T-bar wrench and install the piston into the bottom of the cell, working it up and down to ensure that the piston moves freely. The bottom of the cell will have a shorter recess than the top. Position the piston so that it is near the bottom edge of the cell and unscrew it from the wrench. (d) Install the hydraulic end cap onto the bottom of the cell. Press in on the backpressure ball on the stem of the hydraulic end cap to relieve pressure and allow the cap to slide into the cell more easily. Install the six set screws and tighten. (e) Turn the cell upright and connect the hydraulic pump to the stem on the bottom end cap. Close the black valve on the pump. Pump hydraulic fluid into cell until the top of the floating piston is 10 cm from the top of the cell. (f) Fill the cell up to the top of the “O” ring groove with drilling fluid (approximately 160 ml) and carefully place an “O” ring into the groove. (g) Set an aloxite disk of the desired permeability on top of the “O” ring. The aloxite disk should be saturated in the appropriate fluid prior to testing (i.e. water or brine for water based muds and kerosene for oil based muds). (h) Install the top end cap with nipple adapter and valve onto the cell and tighten the six set screws. Close the valve after filling the valve stem with the aloxite disk saturation fluid. Open the black valve on the hydraulic pump. (i) Disconnect the hydraulic pump from the bottom end cap and install the cell into the heating jacket. Make sure that the cell support has been pulled outward using the handle, then lower the cell assembly and rotate it so that the pin in the bottom of the heating jacket will seat into the bottom of the cell. This prevents the cell rotating. Place a metal stem dial thermometer or thermocouple in the hole at the top of the cell. (j) Reconnect the hydraulic pump to the bottom end cap. Leave the black valve on the pump open. (k) Place the backpressure receiver onto the top of the valve adapter and lock the back pressure receiver in place by installing the retaining pin. (l) Install the nitrogen pressurizing unit onto the top of the backpressure receiver and lock it in place with the retaining pin.

Once the cell has been loaded, the measurements are made as follows: (a) Set a timer for 30 minutes (standard test) or other desired filtration test time. (b) Open the green valve between the cell and the backpressure receiver to start the filtration. Verify both the cell pressure as read on the hydraulic pump gauge and the backpressure as read on the pressure regulator are the test design parameters. Adjust if required. (c) One minute after the desired pressure is applied, open the drain valve on the backpressure receiver and collect the filtrate that comes out. Make sure that the drain hose has been connected, and collect the filtrate in a graduated cylinder. Continue to collect the liquid until the reservoir blows dry. (d) Collect filtrate in the same way as outlined above after 7.5 minutes has elapsed and again after 15 minutes has elapsed. (e) The pressure may slowly decrease as the test continues due to volume loss through filtration, or the pump may allow the hydraulic oil to seep slightly. Additional pressure should be applied to the cell in order to maintain a constant pressure for the duration of the test. (f) In reporting results, quote the raw data as well as calculating the following: PPT Loss (ml)=2×30 min value] and Spurt Loss (ml)=2×[7.5 min value−(30 min value−7.5 min value)].

### 2. Results

The results of PPT experiments at a temperature of 140° F. (60° C.) under a differential pressure of 1000 psi (6.895 MPa) using an aloxite disk with a pore diameter of 35 microns are listed in TABLE 4.

The base mud used in these experiments was described in TABLE 2. An additive package containing a mixture containing 15 ppb of the full size range of FracBlack™ thermoset nanocomposite particles added to BlacKnite™ (an embodiment of the invention), when used at 2% by volume, lowers the effluent volume measured after 30 minutes from 3.5 ml for either the base mud or the mud containing 2% by volume of BlacKnite™ by itself, to 3 ml for the mud containing this additive.

TABLE 4
Results of PPT test at a temperature of 140° F.
(60° C.) under a differential pressure of 1000 psi (6.895 MPa),
using an aloxite disk with a pore diameter of 35 microns.
BlacKnite ™ or a mixture containing 15 ppb of the full
size range of FracBlack ™ thermoset nanocomposite
particles added to BlacKnite ™ were incorporated at 2% by
volume into the base mud in the tests evaluating their effects as additives.

| | | | Base Mud + |
|---|---|---|---|
| | | Base Mud + | BlacKnite ™ + |
| | Base Mud | BlacKnite ™ | FracBlack ™ |
| Time (min) | Volume (ml) | Volume (ml) | Volume (ml) |
| 1 | 1 | 1.2 | 0.8 |
| 7.5 | 2 | 2.4 | 1.8 |
| 15 | 2.5 | 2.7 | 2.3 |
| 30 | 3.5 | 3.5 | 3 |
| PPT Loss | 7 | 7 | 6 |
| Spurt Loss | 1 | 2.6 | 1.2 |
| Effluent | Opaque brown | Opaque dark brown | Opaque dark brown |
| Cake | Brown | Dark brown | Dark brown |

### D. Fracture Sealing Experiments

### 1. Experimental Procedure

The experiments consisted of a series of tests, using tapered fixed fracture gaps, at 140° F., allowing leak-off through the rocks. One goal was to determine the maximum fracture width that a mud system using two differing Blacknite fluid loss control agents would seal. Another goal was, having sealed the fracture, to determine the amount of leak-off through the rocks, the fluid loss through the seal, and the stress needed to break that seal.

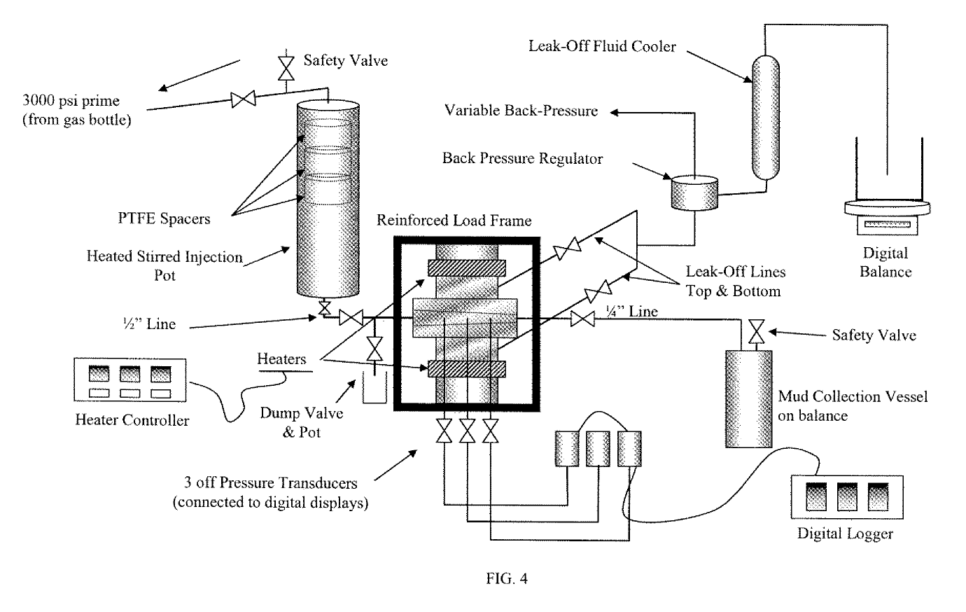

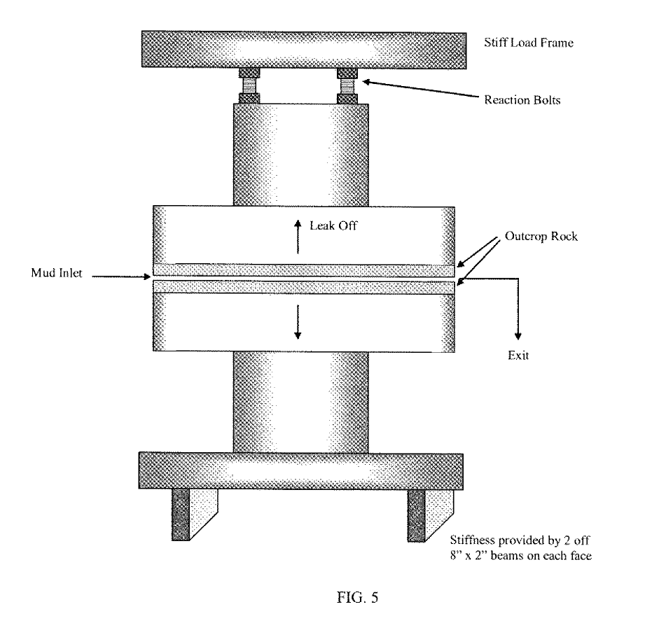

FIG. 4 shows the setup used for the fracture sealing experiments. FIG. 5 show how the fracture width is secured during the fracture sealing experiments. The hydraulic ram provides insufficient stiffness, resulting in the lack of control of the fracture width. The reaction bolts overcome this limitation, thus securing the fracture width.

The following mud blending procedures are used: (a) The entire batch of base mud is stirred for 1 hour on the Ikawerk medium shear stirrer at 300 rpm to ensure it is homogenous. A 3-liter sample is then measured off by mass into a large plastic beaker. This sample is placed under the Ikawerk medium shear stirrer at 300 rpm. (b) If a fluid loss control agent is to be incorporated into the mud as an additive, this fluid loss control agent is shaken vigorously by hand for 5 minutes, immediately weighed out into a beaker using a Mettler 6100 balance, and added to the mud as it stirs by pouring slowly into the edge of the vortex created.

The following cell construction procedures are used: Two 12.5 mm Ohio Sandstone rocks are used, with the appropriate shims (glued together if necessary) separating them to give the required fracture width (a 1000-500 micron taper in the tests reported here).

The following cell placement procedures are used: The cell is placed centrally within the reaction frame, between appropriate spacers, with two reaction bolts above. These bolts are left loose while the cell is heated to 140° F. using heated platens on both cell pistons. The cell is then left 18 to 24 hours to heat up and stabilize, after which the bolts are tightened and then the appropriate feeler gauge is used to determine the width of the fracture. This allows the bolts to be tensioned to the point where the fracture is the required width and the square rings in the cell are compressed so the fracture does not open on injection.

The following saturation procedures are used: The cell's leak-off lines are connected to a vacuum pump via a liquid catch pot. A syringe type pressure vessel with a piston is attached to the exit valve of the cell. Above the piston the vessel is filled with 2% KCl solution; to the bottom a gas regulator and supply are attached. The cell is then dry vacuumed for 20 minutes, after which the exit valve is opened and the gas pressure driving the brine increased gradually over 10 minutes (or until brine emerges in liquid catch pot) to 50 psi, at which point the vacuum pump is switched off. Using the leak-off valves, approximately 50 ml of brine is allowed to pass through each rock thoroughly saturating them. The transducer lines are bled at this point to ensure no gas bubbles are present. This procedure also acts as leak integrity test for the cell and associated tubing.

The following injection procedures are used: The mud is placed in the stirred injection pot with the stirrer running. The mud is then heated to 140° F. Once the mud is at the required temperature and all checks have been made, the stirrer is switched off, and the pressure within the injection pot is increased to the required injection pressure (500 psi in the tests reported here). The bypass valve from the bottom of the pot is then opened briefly to allow the dead volume of the injection tubing to be filled with mud, before the inlet valve to the cell is opened quickly injecting the mud into the cell. If a plug forms sealing the cell, the cell is held for one hour at the injection pressure. Pressures within the cell are monitored.

The following pressure ramp procedures are used: After the cell is held for one hour at the injection pressure, the pressure is increased at a rate of 100 psi/minute, until either the required pressure for the test is achieved or the plug breaks. Meanwhile, the mass at the exit and the volume of fluid leak-off are monitored.

Pressure measurements were made using logged 0-10000 psi transducers attached to three ports along the side of the cell via ⅛″ tubing. Mass measurements at the cell exit were made using a logged (Mettler 6100) balance. The leak-off is regulated by a GDS Syringe Pump set to 50 psi backpressure.

### 2. Results

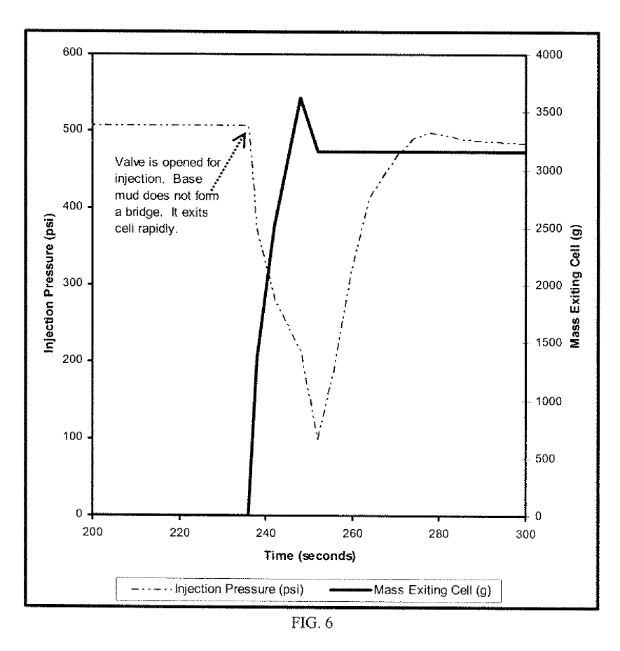

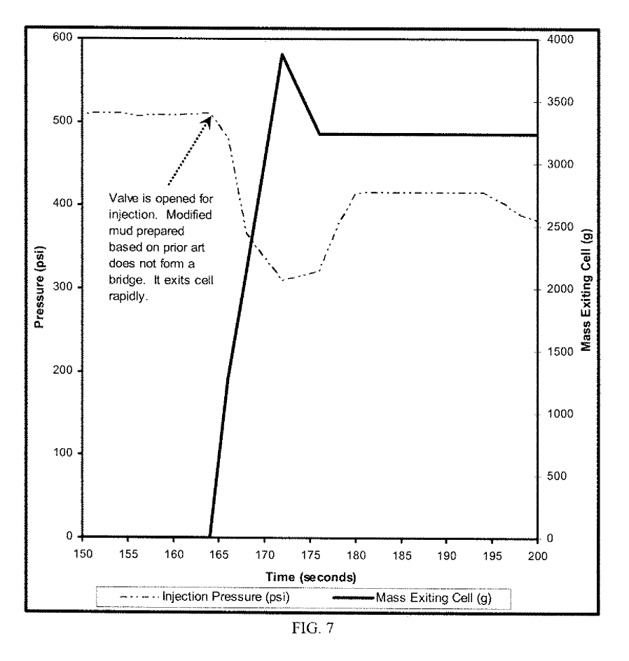

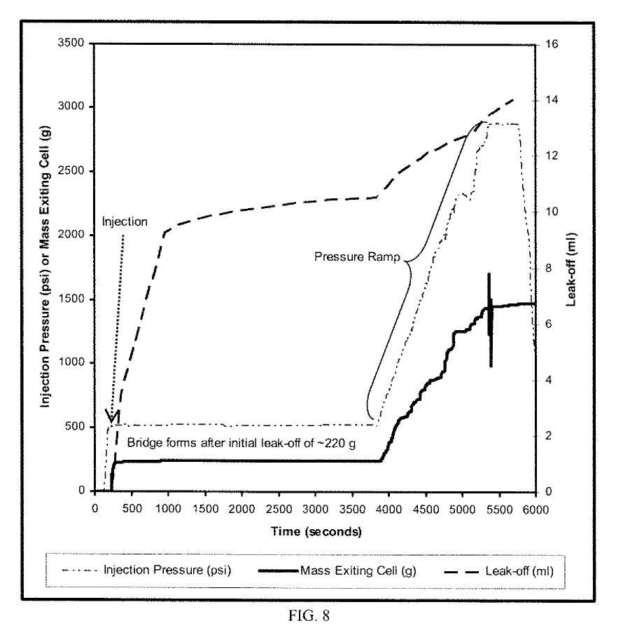

The main results of fracture sealing experiments, under an injection pressure of 500 psi (3.447 MPa) at a temperature of 140° F. (60° C.) across a tapered fracture possessing a width of 0.5 millimeters at its opening, are shown in FIG. 6 for the base mud, FIG. 7 for an additive package containing BlacKnite™ by itself (this additive package is an example of the prior art) added at 2% by volume into the base mud, and FIG. 8 for an additive package containing 15 ppb of the full size range of FracBlack™ thermoset nanocomposite particles added to BlacKnite™ (this additive package is an exemplary embodiment of the present invention) added at 2% by volume into the base mud. The base mud used in these experiments was described in TABLE 2.

FIG. 6 shows that, when the valve is opened for injection, the base mud fails to form a bridge across the fracture opening and instead exits the cell rapidly.

FIG. 7 shows that, when the valve is opened for injection, the formulation where an additive package containing BlacKnite™ by itself was added at 2% by volume into the base mud also fails to form a bridge across the fracture opening and instead exits the cell rapidly.

FIG. 8 shows that, when the valve is opened for injection, the formulation where an additive package containing 15 ppb of the full size range of FracBlack™ thermoset nanocomposite particles added to BlacKnite™ was added at 2% by volume into the base mud rapidly forms a bridge across the fracture opening after a small (220 g) leak-off that takes place during bridge formation. Once the bridge is formed, it is stable under an injection pressure of 500 psi (3.447 MPa) at a temperature of 140° F. (60° C.) as shown by the plateau regions in the curves labeled “Mass Exiting Cell (g)” and “Leak-off (ml)” that persist until the injection pressure is ramped up to higher levels in the final stage of the experiment. The stability of the bridge until the injection pressure is ramped up provides a laboratory-scale demonstration of the ability of an additive package of the invention to strengthen a wellbore.

What is claimed:

1. An additive package comprising thermoset nanocomposite particles that are present in an amount of at least about 0.1 ppb, where the unit “ppb” (pounds per barrel) is defined relative to a so-called “blue barrel” possessing a volume of 42 gallons; and additional ingredients comprising one or more of the following: glycols, surfactants, gilsonites, lignites, carbon black, and combinations thereof, for incorporation into a fluid comprising one or more of the following: drilling fluid, a drill-in fluid, a completion fluid, and a workover fluid.

2. Additive package of claim 1, wherein said fluid includes a water-based drilling mud.

3. Additive package of claim 1, wherein said fluid includes an oil-based drilling mud.

4. Additive package of claim 1, wherein said fluid includes an invert emulsion drilling mud.

5. Additive package of claim 1, wherein said fluid includes a synthetic drilling mud.

6. Additive package of claim 1, incorporated into said fluid to reduce fluid losses to a formation compared to an additive package free fluid; where reduced fluid loss is demonstrated by decreased HPHT loss, decreased fluid loss in a PPT experiment, or a combination thereof, measured via procedures recommended by the applicable standards of the American Petroleum Institute (API RP 13B-1, API RP 13B-2), using a testing mode, equipment, and set of test conditions that meet the requirements of one or more of these standards.

7. Additive package of claim 1, incorporated into said fluid to enhance the wellbore strength, as measured by the fracture breakdown pressure in laboratory or field testing, relative to a use of said fluid without said additive package.

8. Additive package of claim 1, wherein said particles are present in an amount ranging from about 1 ppb to about 75 ppb.

9. Additive package of claim 1, wherein said particles are present in an amount ranging from about 5 ppb to about 40 ppb.

10. Additive package of claim 1, wherein said particles have a shape selected from the group of shapes consisting of a powder, a pellet, a grain, a seed, a short fiber, a rod, a cylinder, a platelet, a bead, a spheroid, or mixtures thereof.

11. Additive package of claim 1, wherein said particles have an average roundness of at least about 0.7 and an average sphericity of at least about 0.7 as measured by the use of a Krumbien/Sloss chart, and diameters ranging from about 5 microns to about 10 millimeters.

12. Additive package of claim 1, wherein said particles comprise a copolymer of styrene and divinylbenzene.

13. Additive package of claim 1, wherein said particles comprise a terpolymer of styrene, ethylvinylbenzene and divinylbenzene.

14. Additive package of claim 1, wherein said particles incorporate carbon black particles possessing a length that is less than about 0.5 microns in at least one principal axis direction as a nanofiller.

15. Additive package of claim 1, wherein said particles are synthesized via suspension polymerization and then postcured by heat treatment.

16. Additive package of claim 1, optionally containing additional ingredients of any suitable dimensions selected from the group consisting of calcium carbonate, crushed or ground marble, limestone, dolomite (calcium magnesium carbonate), zinc carbonate, barium carbonate, lithium carbonate, iron carbonate, other metal carbonates, hematite, ilmenite, magnesium oxide, manganese tetroxide, zinc oxide, magnesium oxychloride, colemanite, ulexite, analcite, apatite, bauxite, brucite, gibsite, hydrotalcite, other metal oxides, metal hydroxides, magnesium oxysulfate, other metal sulfates, metal tungstates, metal fluorides, lithium phosphate, other metal phosphates, magnesium sulfite, lead sulfide, metal peroxides, magnesium potassium phosphate hexahydrate, magnesium hydrogen phosphate trihydrate, magnesium ammonium phosphate hexahydrate, metal fluorosilicates, sodium chloride, other water-soluble salts, crushed or ground nut shells, crushed or ground seeds, crushed or ground fruit pits, materials obtained from barks of trees, calcined petroleum coke, asphalts, barite particles, clay particles, mica particles, talc particles, silica particles, sands, feldspar, bauxite particles, ceramic particles, cement particles, melamine, solid or hollow microspheres, graphitic materials, other forms of carbon, celluloses, starches, polysaccharides, acrylic polymers, natural rubbers, synthetic rubbers, styrene-diene diblock and triblock copolymers, other natural or synthetic polymers, expanded polystyrene beads, other foam beads, carbon fibers, glass fibers, polymer fibers, other fibers, water, dispersants, thinners, crystalline additives of low molecular weight (such as 1-S-endo-Borneol, camphor, iodine, beta carotene, lycophene, cholesterol, lanosterol, or agnosterol), and combinations thereof.

17. An additive package comprising particles of specific gravity ranging from about 0.75 to about 1.75 that are present in an amount of at least about 0.1 ppb; and additional ingredients selected from the group consisting of glycols, surfactants, gilsonites, lignites, carbon black, and combinations thereof, for incorporation into a fluid selected from the group consisting of: a drilling fluid, a drill-in fluid, a completion fluid, and a workover fluid.

18. Additive package of claim 17, wherein said fluid includes a water-based drilling mud.

19. Additive package of claim 17, wherein said fluid includes an oil-based drilling mud.

20. Additive package of claim 17, wherein said fluid includes an invert emulsion drilling mud.

21. Additive package of claim 17, wherein said fluid includes a synthetic drilling mud.

22. Additive package of claim 17, incorporated into said fluid to reduce fluid losses to a formation compared to an additive package free fluid; where reduced fluid loss is demonstrated by decreased HPHT loss, decreased fluid loss in a PPT experiment, or a combination thereof, measured via procedures recommended by the applicable standards of the American Petroleum Institute (API RP 13B-1, API RP 13B-2), using a testing mode, equipment, and set of test conditions that meet the requirements of one or more of these standards.

23. Additive package of claim 17, incorporated into said fluid to enhance the wellbore strength, as measured by the fracture breakdown pressure in laboratory or field testing, relative to use of said fluid without said additive package.

24. Additive package of claim 17, wherein said particles are present in an amount ranging from about 1 ppb to about 75 ppb.

25. Additive package of claim 17, wherein said particles are present in an amount ranging from about 5 ppb to about 40 ppb.

26. Additive package of claim 17, wherein said particles have a shape selected from the group of shapes consisting of a powder, a pellet, a grain, a seed, a short fiber, a rod, a cylinder, a platelet, a bead, a spheroid, or mixtures thereof.

27. Additive package of claim 17, wherein said particles have an average roundness of at least about 0.7 and an average sphericity of at least about 0.7 as measured by the use of a Krumbien/Sloss chart, and diameters ranging from about 5 microns to about 10 millimeters.

28. Additive package of claim 17, wherein said particles have a specific gravity ranging from about 0.8 to about 1.25.

29. Additive package of claim 17, wherein said particles have a specific gravity ranging from about 1.0 to about 1.25.

30. Additive package of claim 17, wherein said particles have a specific gravity ranging from about 1.02 to about 1.15.

31. Additive package of claim 17, wherein said particles comprise a copolymer of styrene and divinylbenzene.

32. Additive package of claim 17, wherein said particles comprise a terpolymer of styrene, ethylvinylbenzene and divinylbenzene.

33. Additive package of claim 17, wherein said particles incorporate carbon black particles possessing a length that is less than about 0.5 microns in at least one principal axis direction as a nanofiller.

34. Additive package of claim 17, wherein said particles are synthesized via suspension polymerization and then postcured by heat treatment.

35. Additive package of claim 17, optionally containing additional ingredients of any suitable dimensions selected from the group consisting of calcium carbonate, crushed or ground marble, limestone, dolomite (calcium magnesium carbonate), zinc carbonate, barium carbonate, lithium carbonate, iron carbonate, other metal carbonates, hematite, ilmenite, magnesium oxide, manganese tetroxide, zinc oxide, magnesium oxychloride, colemanite, ulexite, analcite, apatite, bauxite, brucite, gibsite, hydrotalcite, other metal oxides, metal hydroxides, magnesium oxysulfate, other metal sulfates, metal tungstates, metal fluorides, lithium phosphate, other metal phosphates, magnesium sulfite, lead sulfide, metal peroxides, magnesium potassium phosphate hexahydrate, magnesium hydrogen phosphate trihydrate, magnesium ammonium phosphate hexahydrate, metal fluorosilicates, sodium chloride, other water-soluble salts, crushed or ground nut shells, crushed or ground seeds, crushed or ground fruit pits, materials obtained from barks of trees, calcined petroleum coke, asphalts, barite particles, clay particles, mica particles, talc particles, silica particles, sands, feldspar, bauxite particles, ceramic particles, cement particles, melamine, solid or hollow microspheres, graphitic materials, other forms of carbon, celluloses, starches, polysaccharides, acrylic polymers, natural rubbers, synthetic rubbers, styrene-diene diblock and triblock copolymers, other natural or synthetic polymers, expanded polystyrene beads, other foam beads, carbon fibers, glass fibers, polymer fibers, other fibers, water, dispersants, thinners, crystalline additives of low molecular weight (such as 1-S-endo-Borneol, camphor, iodine, beta carotene, lycophene, cholesterol, lanosterol, or agnosterol), and combinations thereof.

36. A method comprising adding an additive package comprising thermoset nanocomposite particles that are present in an amount of at least about 0.1 ppb, where the unit “ppb” (pounds per barrel) is defined relative to a so-called “blue barrel” possessing a volume of 42 gallons; and additional ingredients comprising one or more of the following: glycols, surfactants, gilsonites, lignites, carbon black, and combinations thereof, to one or more of the following: a drilling fluid, a drill-in fluid, a completion fluid, or a workover fluid.

37. The method of claim 36, wherein said additive package results in reduced fluid losses to a formation compared to an additive package free fluid; where reduced fluid loss is demonstrated by decreased HPHT loss, decreased fluid loss in a PPT experiment, or a combination thereof, measured via procedures recommended by the applicable standards of the American Petroleum Institute (API RP 13B-1, API RP 13B-2), using a testing mode, equipment, and set of test conditions that meet the requirements of one or more of these standards.

38. The method of claim 36, wherein said additive package enhances the wellbore strength, as measured by the fracture breakdown pressure in laboratory or field testing, compared to an additive package free fluid.

39. A method comprising adding an additive package comprising particles of specific gravity ranging from about 0.75 to about 1.75 that are present in an amount of at least about 0.1 ppb, where the unit “ppb” (pounds per barrel) is defined relative to a so-called “blue barrel” possessing a volume of 42 gallons; and additional ingredients comprising one or more of the following: glycols, surfactants, gilsonites, lignites, carbon black, and combinations thereof, to one or more of the following: a drilling fluid, a drill-in fluid, a completion fluid, or a workover fluid.

40. The method of claim 39, wherein said additive package results in reduced fluid losses to a formation compared to an additive package free fluid; where reduced fluid loss is demonstrated by decreased HPHT loss, decreased fluid loss in a PPT experiment, or a combination thereof, measured via procedures recommended by the applicable standards of the American Petroleum Institute (API RP 13B-1, API RP 13B-2), using a testing mode, equipment, and set of test conditions that meet the requirements of one or more of these standards.

41. The method of claim 39, wherein said additive package enhances the wellbore strength, as measured by the fracture breakdown pressure in laboratory or field testing, compared to an additive package free fluid.
